(19) United States
(12) Patent Application Publication
(10) Pub. No.: US 2003/0097205 A1
(43) Pub. Date: May 22, 2003

(54) Control scheme and system for active vibration isolation

(76) Inventors: Bausan Yuan, San Jose, CA (US); Ting-Chien Teng, Fremont, CA (US); Katsumi Toma, Tokyo (JP)

Correspondence Address: Pennie & Edmonds, LLP, 3300 Hillview Avenue, Palo Alto, CA, 94304, US

(21) Appl. No.: 09/988,520

(22) Filed: Nov. 20, 2001

(51) Int. Cl. G05B 19/18

(52) U.S. Cl. 700/301; 700/60

(57) ABSTRACT

This invention provides a platform and stage support apparatus and method that isolates the platform from vibration and maintains platform position within an exposure apparatus while the stage is moved about. The apparatus includes a base, platform, stage, pneumatic and electromagnetic supports from the base to the stage, and a controller for positioning the platform in response to data from stage and platform position sensors and pneumatic support pressure sensors. The method includes using a model that provides a target pressure for each pneumatic support in response to an input stage location. The apparatus and method use the pneumatic supports to carry the majority of platform and stage weight, thus requiring less force from the electromagnetic supports to maintain a desired platform position.

### FIELD OF THE INVENTION

This invention relates to an apparatus and method for supporting a platform. More specifically it relates to an apparatus and method of vibration isolation for a platform on which lithography stages are positioned.

### BACKGROUND OF THE INVENTION

Lithography devices transfer patterns from a reticle to a substrate. The typical device moves both substrate and reticle during the process. To transfer a functional pattern the process resolution must often be in the sub-micrometer range. Such precision requires extremely fine control of the substrate position, since the reticle pattern is focused at a point that is fixed in three dimensions. Processing typically requires moving a stage in two dimensions on a platform with the substrate fixed to the stage. This stage relies upon the platform to fix the location in the third dimension, which is usually vertical.

Simultaneously this platform is also preferably equipped with devices that dampen vibrations so that they do not degrade the focused image. Rigid fixtures or supports would most easily control platform position, but they are unsatisfactory because they transmit vibration to an undesirable degree. Compliant supports, on the other hand, are susceptible to tilting caused by the changes in stage position and the resulting change in the load on the supports. Active compliant supports, such as pneumatic supports of variable pressure and electromagnetic supports, such as voice coils or other mechanisms employing Lorentz forces, can compensate for changes in platform position, but involve other disadvantages.

Pneumatic supports that rely on changing air pressure to change position can support great weight and dampen vibration simultaneously. But because they rely on changing air pressure in a volume their response time is often slower than necessary to meet the requirements of today's lithography processes. They also have correspondingly long settling times. The stage movement in lithography processes would require much pressure adjustment to keep the platform positioned and each adjustment would add its own response and settling times resulting in an extended process time.

Electromagnetic supports must be relatively large to support a platform and stage in a modern lithography apparatus. Also, they consume significantly more power than pneumatic supports since the Lorentz forces on which they typically operate require the constant flow of electrical current. A direct product of this power requirement is heat, which can be conducted throughout the apparatus and cause thermal distortion of the substrate as well as decreasing the operational life of the electromagnetic unit itself.

### SUMMARY OF THE INVENTION

The present invention is an apparatus and method that isolates a stage from vibration while the stage positions an object during a manufacturing or inspection process. An apparatus embodying the invention supports a platform from a base using both pneumatic and electromagnetic supports, the platform further supporting a stage. In one aspect of the invention pneumatic supports themselves support a majority of the platform and stage weight. The electromagnetic supports are then used primarily to maintain a desired stage position and thus may be sized to reduce energy consumption and heat. A preferred embodiment of the invention employs three electromagnetic supports paired in parallel with three pneumatic supports, the pairs operating to support the platform and maintain a desired stage position. In this same embodiment, the support pairs are configured on the base so that the weight of the platform is divided among the three pairs.

The present invention also provides a method for supporting the platform and stage so that the platform is maintained at a specified position as the stage is moved about the platform during a process. In one aspect of this method the supports, platform, and stage are modeled prior to use in the process. With the stage at a given position, pneumatic support pressure information is incorporated into a mathematical model, or look-up table, or matrix. A model is created that provides desired, modeled, or target pneumatic support pressures for a given stage position. These target pressures are preferably those pressures that cause the pneumatic supports to support a majority, more preferably all, of the platform and stage weight. During processing, as the stage is moved about the platform, stage position is fed into the model which in turn provides the target pressure for each pneumatic support. The pneumatic supports are then regulated or driven to the target pressures. Because this aspect of the invention controls the pneumatic supports based on pressure, it decreases the effects of the settling time associated with a pneumatic support that is controlled based on position. In concert with this, platform position is monitored and the electromagnetic supports regulated to move the platform towards the specified position to speed the response of the total system.

The present invention is also directed to an exposure apparatus and a wafer and device manufactured with the exposure apparatus. In addition, the present invention is directed to a method of making a wafer and a device.

### BRIEF DESCRIPTION OF THE DRAWINGS

The foregoing and other aspects and advantages of the present invention will be better understood from the following detailed description of preferred embodiments of the invention with reference to the drawings, in which:

FIG. 1(a) is a plan view of a preferred embodiment of the apparatus of the present invention;

FIG. 1(b) is a cross sectional view of the preferred embodiment of the apparatus depicted in FIG. 1(a);

FIG. 2 is a diagram of the forces in the preferred embodiment of the apparatus shown in FIG. 1;

FIG. 3 is a flow chart of a preferred embodiment of a method of the present invention;

FIGS. 4(a)-(g) illustrate steps for acquiring data from which to model the pneumatic supports of a preferred embodiment of a method of the present invention;

FIGS. 5(a)-(c) depict a control apparatus employed by the method of FIG. 3 wherein: FIG. 5(a) illustrates the active elements of the control apparatus employed during the initialization step of the method of FIG. 3; FIG. 5(b) illustrates the active elements of the control apparatus employed during the activation step of the method of FIG. 3; and FIG. 5(c) illustrates the active elements of the control apparatus employed during the processing steps of the method of FIG. 3;

FIG. 6 is a diagram of an exposure apparatus incorporating a preferred embodiment of the present invention;

FIG. 7 is a flow chart of a method for fabricating semiconductors; and

FIG. 8 is a detailed flowchart example of step 124 of the flowchart in FIG. 7.

Like reference numerals refer to corresponding elements throughout the several drawings.

### DETAILED DESCRIPTION OF THE PREFERRED EMBODIMENTS

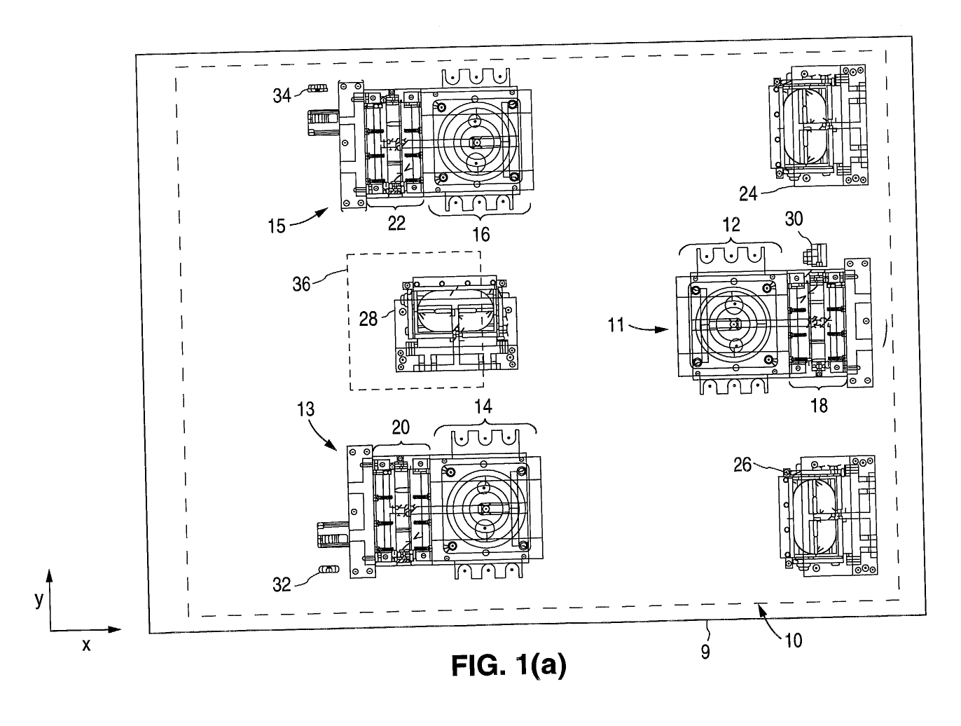

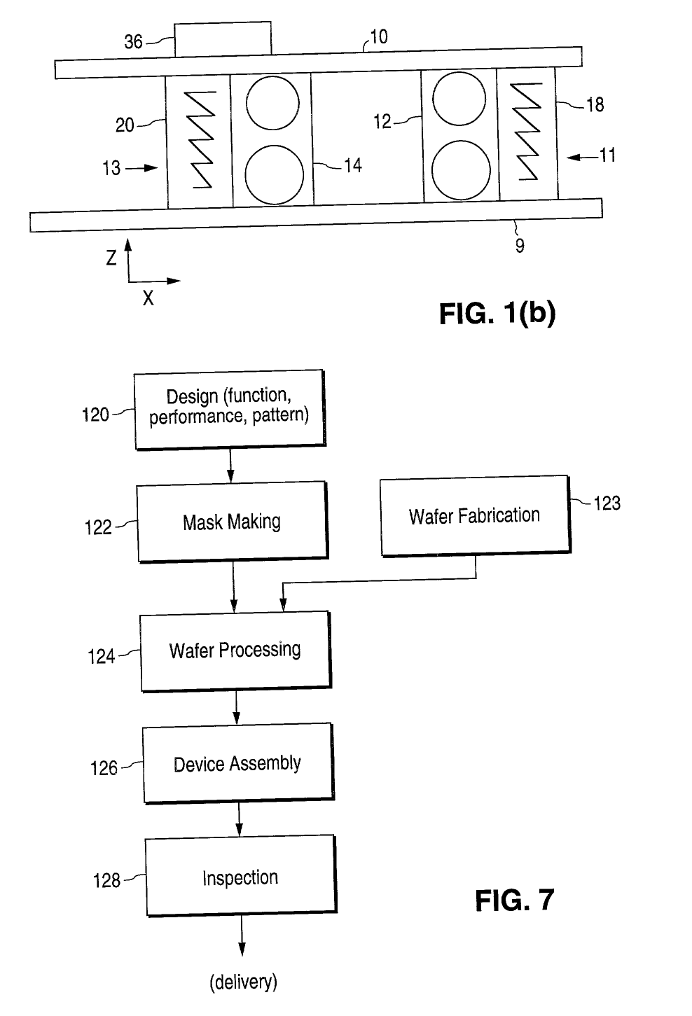

FIG. 1(a) depicts a preferred embodiment of the invention in top plan view, wherein platform 10 and stage 36 are transparent to reveal the various supports. FIG. 1(b) depicts the same embodiment in a front view. In FIG. 1(a) the normal position of platform 10 is show in dashed lines. Pneumatic supports 12, 14, and 16 are below platform 10, supporting it from base 9. Each pneumatic support 12, 14, and 16 is paired with an electromagnetic support 18, 20, and 22, and designated pair 11, 13, and 15, respectively. Electromagnetic supports 18, 20, and 22 are active supports of the voice coil motor variety in a preferred_embodiment of the present invention. Stage 36 moves about platform 10 in a horizontal plane, designated the X-Y plane. In this manner stage 36 is positioned on platform 10 for the various steps in a lithography process. Pairs 11, 13, and 15 act in the vertical direction, designated the Z axis. Other types of active supports may be used for electromagnetic supports 18, 20, and 22 such as an electromagnets, rotary motors, linear motors, or DC motors. Additional electromagnetic actuators 24, 26, and 28, which in a preferred embodiment are also voice coil motors, act on platform 10 to position it in a plane parallel to the plane of stage movement. Electromagnetic actuators 24 and 26 act on platform 10 along one axis of stage movement, controlling the linear translation of platform 10 in this axis. Electromagnetic actuator 28 acts on platform 10 along an axis preferably orthogonal to that of actuators 24 and 26, controlling linear translation of platform 10. Electromagnetic actuators 24, 26, and 28 work in combination to control yaw about the Z axis.

Position sensors 30, 32, and 34 monitor the position of platform 10. Sensors 30, 32, and 34 may be two-axis laser based analog position sensors that have dual-axis capability with each sensor, but one of ordinary skill will recognize that many types of sensors such as encoders, or interferometers could be configured to yield the necessary position data. Position sensors 30, 32, and 34 monitor the Z axis position of platform 10 in the vicinity of support pairs 11, 13, and 15, respectively. Position sensor 30 monitors position along the Y axis and position sensors 32 and 34 both monitor position along the X axis.

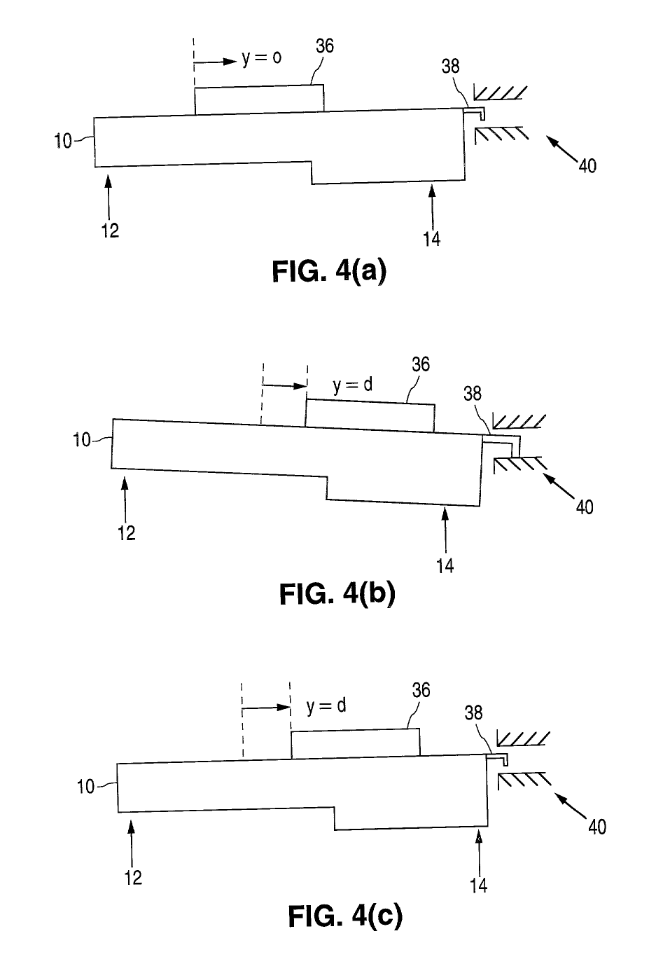

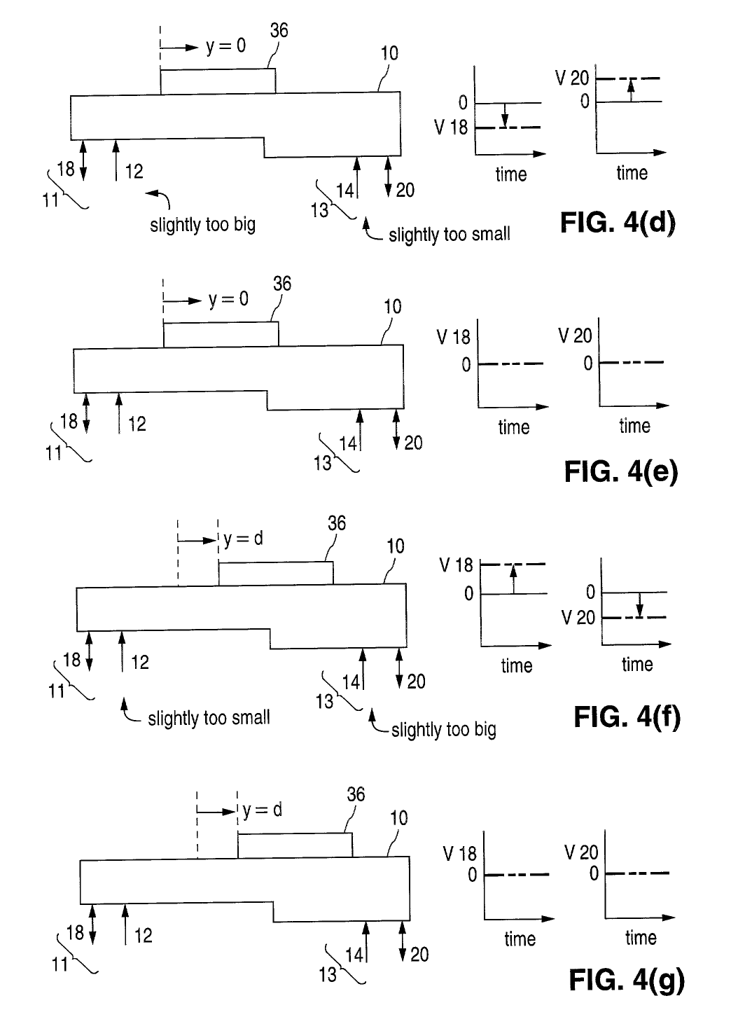

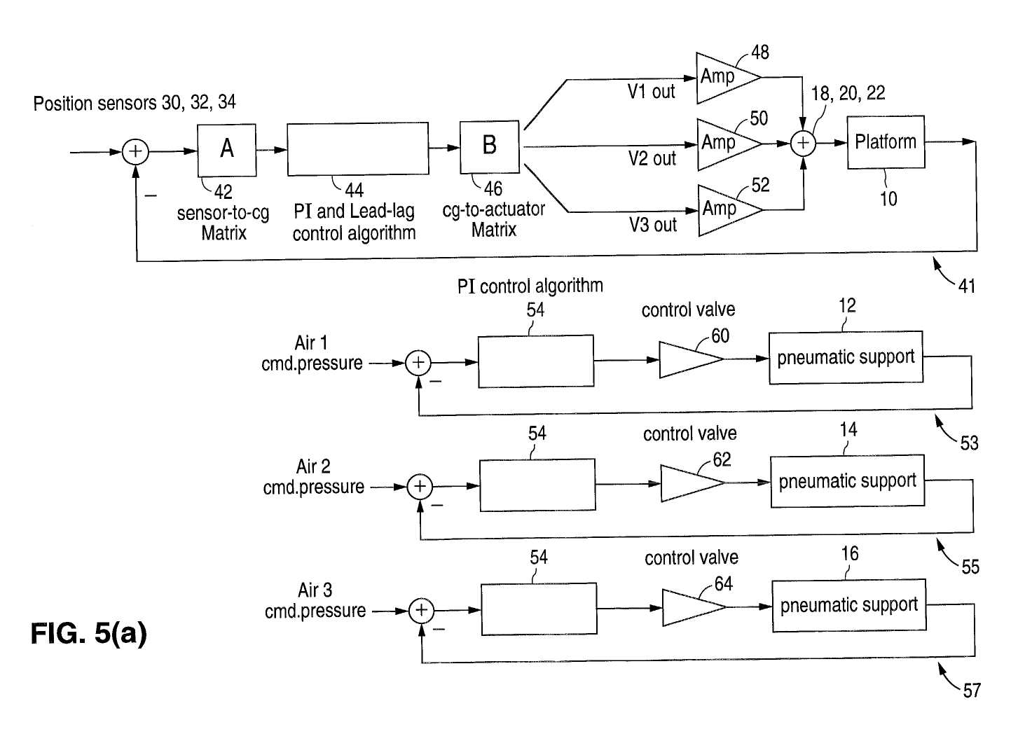

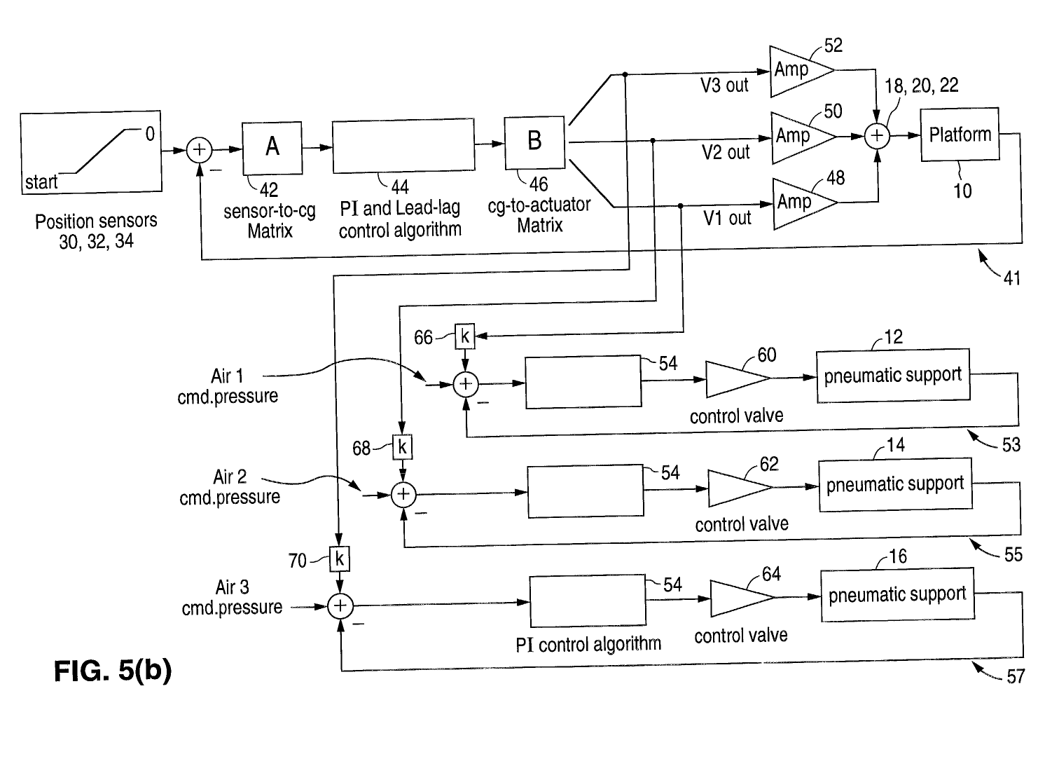

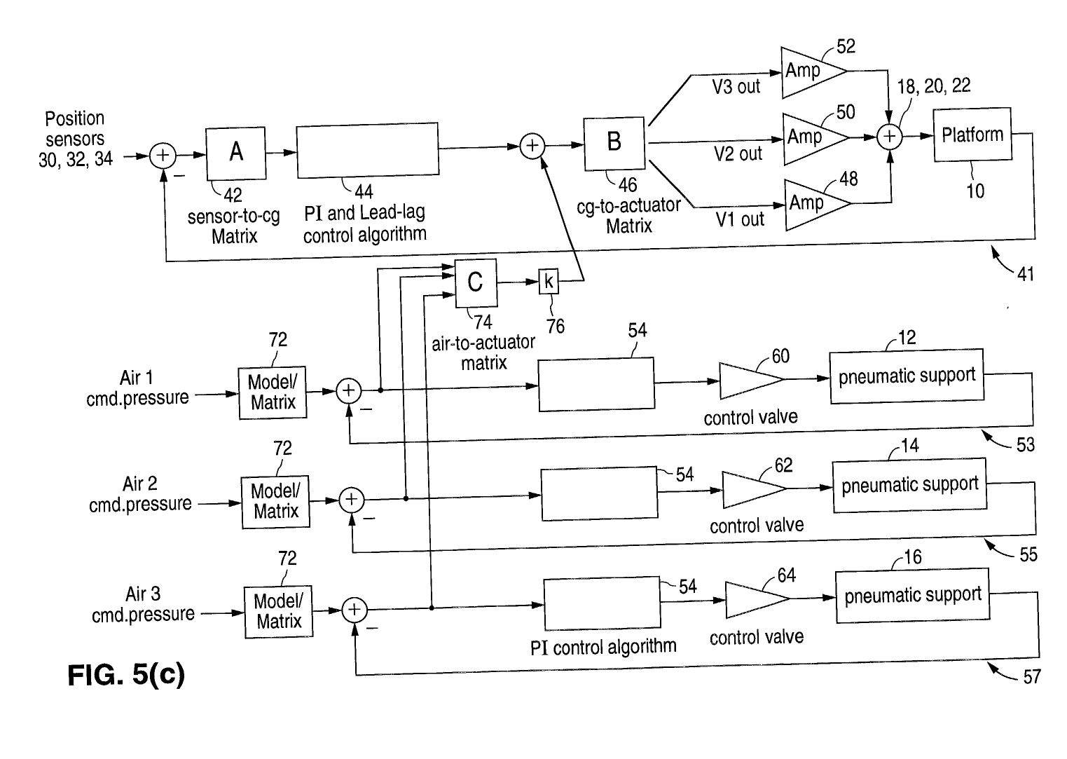

Pneumatic supports 12, 14, and 16 are equipped with integral air pressure sensors and control valves (not shown). Electromagnetic supports 18, 20, and 22 are equipped with amplifiers, or power supply controls, 48, 50 and 52 (FIGS. 5(a)-(c)). Electromagnetic supports apply force in relation to the voltages supplied by amplifiers 48, 50, and 52. A preferred embodiment of a method of the invention (described in the discussion of FIGS. 4(a)-(g)) uses these voltages to aid in setting the target pressures for pneumatic supports 12, 14, and 16. The voltages from amplifiers 48, 50, and 52 are therefore monitored and denoted V18, V20, and V22 in FIGS. 4(d)-(g).

Continuing with FIG. 1(b), the apparatus is shown in a front view, but without position sensors 30, 32, and 34 and without additional electromagnetic actuators 24, 26, and 28 to improve the clarity of the drawing. Support pair 15 is obscured in FIG. 1(b) by pair 13.

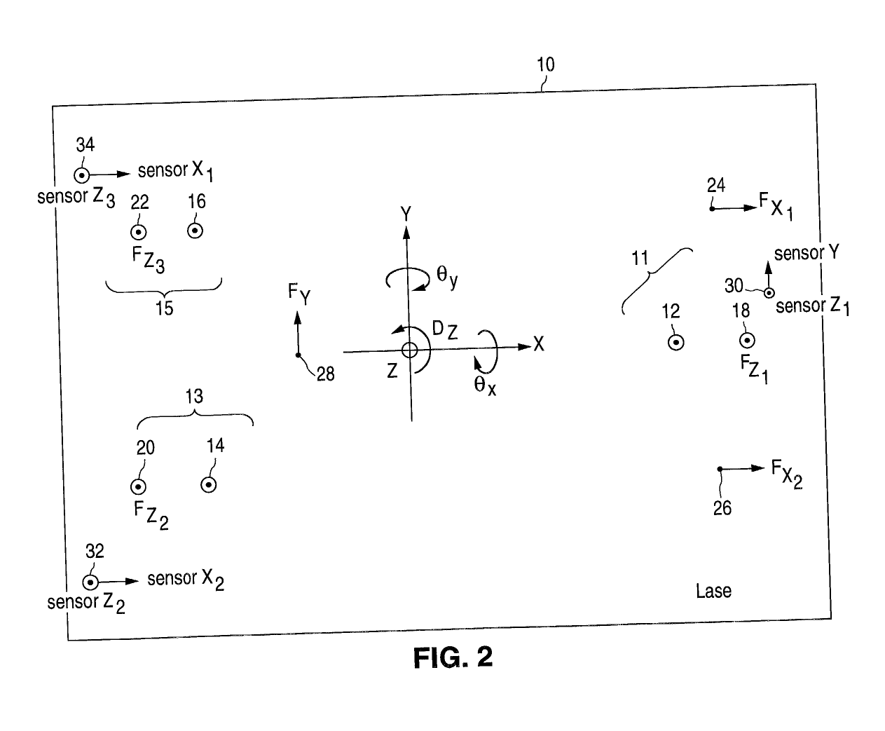

FIG. 2 depicts schematically the orientations of support pairs 11, 13, and 15, as well as those of sensors 30, 32, and 34. Support pairs 11, 13, and 15 are further paired with position sensors 30, 32, and 34, respectively, in the Z direction. Positive displacement is defined as that out of the plane of the figure. Platform position along the X axis is monitored by position sensors 32 and 34, although they are not paired in the same sense as sensor and support are paired in the Z axis, as they are at opposite sides of platform 10.

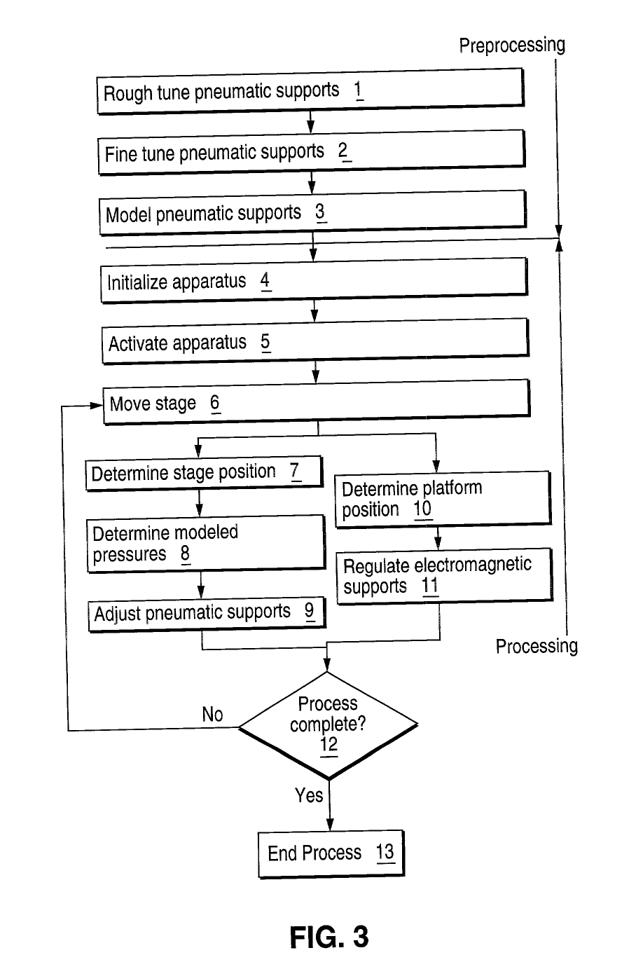

FIG. 3 depicts a preferred embodiment of the method of the invention as practiced using the apparatus of FIGS. 1 and 2. In step 1 (further illustrated in FIGS. 4(a)-4(c) within) the pneumatic supports are rough tuned. Rough tune step 1 creates a tuning matrix that, for a number of given locations of stage 36 (FIG. 1), gives pressures for pneumatic supports 12, 14, and 16 (FIG. 1) that result in supports 12, 14, and 16 supporting preferably all the weight of platform 10 (FIG. 1) and stage 36. In a preferred embodiment this rough tune data is acquired for the X and Y axes defining the surface of platform 10 in FIGS. 1 and 2.

In step 2 of FIG. 3 (further illustrated in FIGS. 4(d)-4(g) within) pneumatic supports 12, 14, and 16 are fine tuned so that for the locations of stage 36 previously used in rough tune step 1, the pressures in pneumatic supports 12, 14, and 16 are further adjusted to ensure that platform 10 is level and at the correct height (or “positioned”). These pressures are entered into the tuning matrix from rough tune step 1. This tuning matrix is used to model the pneumatic supports in step 3. The creation of this model is further illustrated in FIGS. 4(a)-(g). With stage location data determined by location sensors (not shown) the model provides target, or modeled, pressures for pneumatic supports 12, 14, and 16. Steps 1-3 are performed before actually using the apparatus in a process, and are thus labeled “preprocessing steps.” Steps 1-3 need only be repeated to recalibrate or improve the model.

Step 4 of FIG. 3 (further illustrated in FIG. 5(a)) begins the group of steps that are performed during the processing phase of a preferred embodiment of the invention. In step 4, after stage 36 has been loaded with a substrate (not shown), the apparatus is initialized so that the component pneumatic and electromagnetic support pairs 13, 15, and 17 (FIG. 1) become operational without moving to such an extent that they cause damage. Subsequently, in step 5 (further illustrated in FIG. 5(b)), with stage 36 at the initial location, support pairs 13, 15, and 17 are activated to position platform 10, the prelude to actual processing.

In step 6 (further illustrated in FIG. 5(c)) stage 36 is moved about platform 10 pursuant to the process. After a given movement, stage 36 location on platform 10 is determined in step 7 using location sensors (not shown). In step 8 this stage location is input into the model from step 3 to determine target pressures for pneumatic supports 12, 14, and 16. In step 9 pneumatic supports 12, 14, and 16 are adjusted to the target pressures by a control apparatus.

Steps 10 and 11 involve electromagnetic supports 18, 20, and 22. In step 10, position sensors 30, 32, and 34 (FIG. 1) determine platform position, i.e., how level and how high the platform is, and provide this data to a control apparatus (illustrated further in FIG. 5(c) within). The control apparatus then regulates electromagnetic supports 18, 20, and 22 (FIG. 1) in step 11 to correctly position platform 10. Steps 7-9 are shown in parallel with steps 10 and 11 because pneumatic supports 12, 14, and 16 and electromagnetic supports 18, 20, and 22 are independently adjusted.

If the process is not complete, decision 12 is made to repeat steps 6-11 until the process is ended, step 13. One of skill in the art will recognize that these steps are repeated continuously to keep platform 10 preferably continuously positioned while a substrate on stage 36 is being processed. One of skill in the art will also recognize that there are other methods of employing the invention that will accomplish the same.

FIGS. 4(a)-(g) further illustrate the creation of the model in step 3 of the preferred embodiment illustrated in FIG. 3. In the following explanation of FIGS. 4(a)-(g), support pair 15 is omitted for the simplicity of illustrating the process in two dimensions. In the actual preferred embodiment, however, rough tuning and fine tuning are performed on support pairs 11, 13, and 15. FIGS. 4(a)-(c) depict a rough tuning associated with stage 36 moving an incremental distance d, while FIGS. 4(d)-(g) depict a fine tuning associated with that same incremental distance d.

Referring now to FIG. 4(a), which depicts a rough tuning step (step 1) of FIG. 3. Rough tuning consists of moving stage 36 to a variety of known and recorded locations over platform 10 and determining the pressures in pneumatic supports 12 and 14 that keep platform 10 “roughly” positioned for each location. With stage 36 in an initial (Y=0) location, the pressures in pneumatic supports 12 and 14 are noted for that initial stage location and are subsequently referred to as the initial pressures for the initial stage location. “Level” is equivalent to “horizontal” in this embodiment and platform 10 is considered roughly positioned when a plurality of fingers do not contact a similar plurality of hardstops, depicted schematically by finger 38 and hardstop 40 (FIG. 4(a)), i.e., pneumatic supports 12 and 14 support the weight of platform 10 and stage 36 even though platform 10 may not be exactly positioned or level.

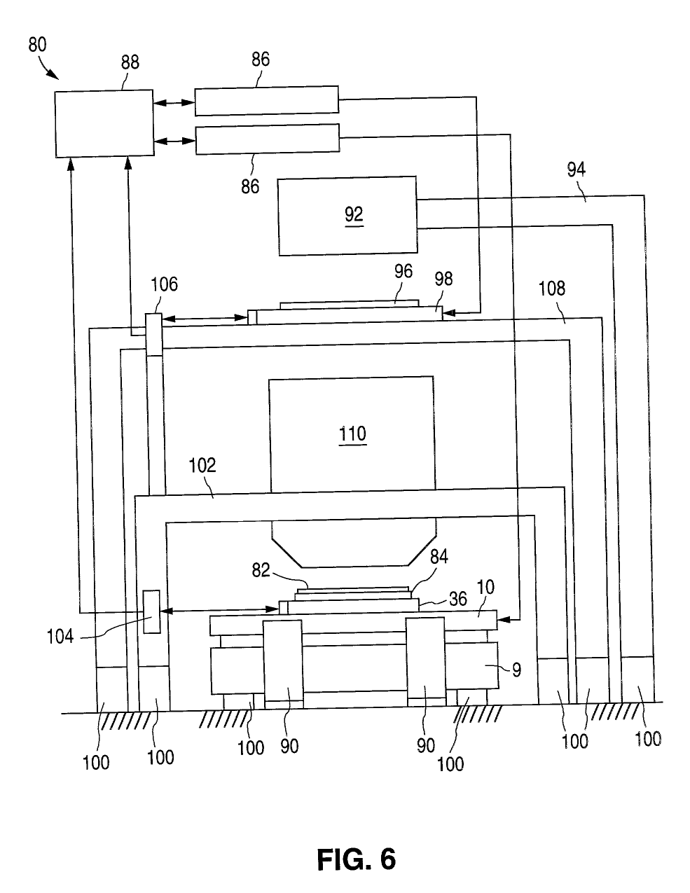

During rough tuning, pneumatic supports 12 and 14 with integral air pressure sensors are activated. Pressure sensors supply data to a central processing unit (“CPU”, for example, controller 88 in FIG. 6) continuously in this embodiment. Also, for this embodiment, the exact location of the center of gravity of the platform and stage is unknown, but the platform positions supplied by position sensors 30, 32, and 34 can be used by the CPU to compensate for this lack.

FIG. 4(b) depicts stage 36 after it has been moved incremental distance d along platform 10 from the known initial location. This movement is along the Y axis describing the plane of the platform. Incremental distance d is approximately one centimeter in this preferred embodiment, but can be as smaller. Distance d is roughly derived by taking the total distance along a direction of stage travel and dividing by the travel time in seconds (but used as a dimensionless number), but one of skill in the art will realize that distance d is an arbitrary value, depending upon the final resolution desired. Finger 38 is now shown contacting hardstop 40 due to the changes in the loads on pneumatic supports 12 and 14. Also, depending upon the resolution desired, distance d can be measured by hand, or by more accurate methods, such as those using an interferometer. In FIG. 4(c), pressures in pneumatic supports 12 and 14 have been manually adjusted until finger 38 is no longer in contact with hardstop 40. These pressures are again noted for that stage location, but in the form of the pressure change from the initial pressures, rather than an absolute or gauge pressure relative to atmospheric.

This rough tune procedure is repeated for multiple increments of distance d along an axis of stage 10 movement with the matrix updated with data from each location. The rough matrix will contain an initial stage location and associated absolute or gauge pressure values. The matrix will also contain subsequent stage locations in terms of the location change from the initial location and the pressure change from the initial pressure.

FIGS. 4(d)-(g) depicts the tuning step (step 2) in the creation of the model (step 3). Fine tuning accomplishes the change from a rough tune where pneumatic supports 12 and 14 supported the weight of stage 36 and platform 10, to a fine tune where platform 10 and stage 36 are both supported and at a desired position. Fine tuning begins with monitoring and controlling the pressures in pneumatic supports 12 and 14. Platform 10 position is again monitored by position sensors 30, 32, and 34. Pneumatic supports 12 and 14 are set to the rough target pressures from the tuning matrix that correspond to a given stage location.

In fine tuning electromagnetic supports 18 and 20 are activated and their output voltages V18 and V20 monitored. Output voltages V18 and V20 represent the amount of force each electromagnetic support is exerting. Graphs of Voltage v. Time accompany FIGS. 4(d)-4(g) to illustrate a steady-state amount of force being exerted by the electromagnetic supports. One of skill in the art will recognize that these graphs will show a change in voltage when the electromagnetic supports adapt to accommodate changes in pneumatic support air pressures. Where the graph indicates the electromagnetic support is exerting no force, or V=0, then the corresponding pneumatic support is properly tuned.

In FIG. 4(d), with stage 36 set at the initial position from the rough tune and with the pressures in pneumatic supports 12 and 14 set to the initial pressures from the tuning matrix, electromagnetic supports 18 and 20 are controlled to drive platform 10 to a desired position. The accompanying plots of output voltages V18 and V20 indicate that electromagnetic supports 18 and 20 are exerting force to keep platform 10 positioned, i.e., electromagnetic support 18 is exerting a force in the negative Z direction and electromagnetic support 20 is exerting a force in the positive Z direction.

To drive these output voltages to zero, as shown in FIG. 4(e), and thus reduce the force each electromagnetic support must exert on the platform, small changes are made to the pressure in pneumatic supports 12 and 14. The resulting pressures are noted for that stage position in the tuning matrix. Stage 36 is then moved incremental distance d as shown in FIG. 4(f) and the process repeated. This fine tuning is repeated for every position from the tuning matrix. FIG. 4(g) shows voltages V18 and V20 after the fine tuning of the second stage location.

After fine tuning is completed a precise tuning matrix will exist for one degree-of-freedom (the direction along which pressure and position data was taken). The second degree-of-freedom is accounted for by rough and fine tuning along a direction on the surface of platform 10 that is preferably perpendicular to the first. A second tuning matrix is then created and the linear combination of the two matrices describes the movement of stage 36 about platform 10. One of skill in the art will recognize that the accuracy of this linear combination is dependent upon the relative linearity of equations describing the individual degrees-of-freedom. Should the two matrices not be even roughly linear, it may be necessary to perform the rough and fine tunes across the surface of the platform.

Additionally, one of skill in the art will realize that other mathematical methods exist for creating a tuning matrix. For example, should the rough tune have indicated a linear relationship existed, the resulting linear equation could be employed during the fine tuning step instead of the look-up matrix. If so employed, then instead of fine tuning by adjusting the pressures in the tuning matrix from the rough tune, the fine tune could be made to the gain of the linear equation.

A preferred embodiment employs a combination of a linear equation with a pressure matrix to model the pressure/location data. The gain is constant as the stage moves in the direction of a particular degree-of-freedom, but a new pressure change value is incorporated into the tuning matrix each time the stage moves distance d, unless the data indicate that a different gain would account more efficiently for the pressure adjustments in the tuning matrix. This combination allows fine tuning using both the gain and the pressures and is thus appropriate for modeling relationships between location and pressure data that are somewhat less than linear. A gain from a relationship such as this is employed in the control schematic of FIGS. 5(a)-(c) (as described below). One of skill in the art will recognize that a variety of mathematical methods exist that would adequately model the pressures required to keep platform 10 positioned as stage 36 moves about.

FIGS. 5(a)-(c) illustrate a schematic of the apparatus employed during the individual processing steps of the method in FIG. 3 with inactive elements omitted for clarity. For example, FIG. 5(a) depicts the control during initialization step 4 of FIG. 3 and so elements not employed during initialization are not shown, even though they would exist and remain connected as indicated in FIGS. 5(b) and 5(c). Referring to FIG. 5(a), the initialization step of the method ensures that the apparatus does not damage itself by extreme initial movement. This is achieved with initial commands that require pneumatic supports 12, 14, and 16 and electromagnetic supports 18, 20, and 22 to remain stationary. Position sensors 30, 32, and 34 are activated and send the current platform position data to sensor-to-cg matrix 42. Matrix 42 converts this data, which is relative to the sensor positions, to determine a calculated position for the center-of-gravity (“CG”). CG position is transferred to control algorithm 44 that contains aspects of both proportional plus integral control (PI) and lead-lag control types. During initialization this algorithm commands the CG to remain at the currently-measured position. This command is then transferred to CG-to-actuator matrix 46 for conversion into commands to electromagnetic actuators 18, 20, and 22 for the CG to remain stationary. These commands to remain stationary work through amplifiers 48, 50, and 52 to power electromagnetic supports 18, 20, and 22 respectively. Platform 10 then remains preferably stationary as a result of electromagnetic support and position sensor initialization.

Again, to ensure that the apparatus does not damage itself by extreme movement, pneumatic supports 12, 14, and 16 are initialized with commands that require the respective air pressures to remain unchanged. Pneumatic supports 12, 14, and 16 are equipped with integral air pressure sensors and control valves 60, 62, and 64. Pneumatic supports 12, 14, and 16, valves 60, 62, and 64, PI control algorithm 54, and commanded pressures 61, 63, and 65 combine to define pneumatic (air) control loops 53, 55 and 57, respectively. The existing pressures from pneumatic supports 12, 14, and 16 are transferred to PI pressure control algorithm 54 which in turn sends signals to remain at those pressures to combinations of the sensors and valves 60, 62, and 64. Thus, the pressure remains fixed in pneumatic supports 12, 14, and 16 and platform 10 preferably moves very little. A preferred embodiment employs Asahi valves, Sumitomo air mounts, and Excel two-axis laser-based analog position sensors.

After initialization of support pairs 11, 13, and 15, platform 10 must be activated, step 5, so that it is positioned and stage 36 is located at the initial location. FIG. 5(b) illustrates the control during activation step 5. With stage 36 located at the initial location, manually or otherwise, pneumatic supports 12, 14, and 16 are commanded to the initial pressures for the initial location acquired during fine tuning. PI control algorithm 54 and air valves 60, 62, and 64 cooperate to drive pneumatic supports 12, 14, and 16 to the initial pressure. Pneumatic control loops 53, 55, and 57 receive additional input from the electromagnetic support control loop 41.

With pneumatic supports 12, 14, and 16 achieving the initial pressure, sensors 30, 32, and 34 are monitoring platform 10 position. This position is input into the electromagnetic support control loop 41. Through the control described in FIG. 5(a), control algorithm (CG servo) 44 commands the electromagnetic supports 18, 20, and 22 to position platform 10 in concert with control PI 54 commands for pneumatic supports 12, 14, and 16 to achieve the initial pressures. Before activation step 5, platform 10 is preferably resting on hardstops 40. Because this is relatively far from the desired position, the data from sensors 30, 32, and 34, after modification by the sensor-to-CG matrix 42, control algorithm 44, and CG-to-actuator matrix 46, will result in a relatively high input signal to amplifiers 48, 50, and 52. These signals are then multiplied by a gains 66, 68, 70 and input into the control loop for the pneumatic support that is the counterpart of a respective support pair. These signals cause the PI control algorithm of pneumatic loops 53, 55, and 57 to also call for faster pressure changes when platform 10 is far out of position. Correspondingly, pressure change rates in pneumatic supports 12, 14, and 16 are decreased as platform 10 nears position. When pneumatic support pressures have stabilized and platform 10 is held in position by electromagnetic supports 18, 20, and 22. Stage 36 is considered to be at the initial location and the apparatus is initialized and ready for use.

Now referring to FIG. 5(c) in which initialization has ended and the system is in the control mode used during processing steps 6-11 of FIG. 3. Stage location is input into model/matrix 72 that was created in step 3 of FIG. 3. Model/matrix 72 supplies a target pressure for pneumatic supports 12, 14, and 16. Pneumatic support control loops 53, 55, and 57 work to attain this target pressure as before. Pneumatic support control loops 53, 55, and 57 now also supply additional input for the electromagnetic support control loop 41.

Signals sent by pneumatic (air) control loops 53, 55, and 57 to pneumatic PI control algorithm 54 are simultaneously sent to the air-to-actuator matrix 74. Matrix 74 modifies the signal based on the small differences in location between each pneumatic support 12, 14, and 16 and its paired electromagnetic support 18, 20, and 22. In this preferred embodiment this matrix is set to “1” because such differences are so slight that they cause little inaccuracy. After conversion gain 76 is applied to the signal to enhance the effect on electromagnetic control loop 41. In a preferred embodiment gain 76 was determined experimentally so that sensors 30, 32, and 34 read within 2-3 μm of the level zero-position at the end of a 30 second operation. At this point the outputs of electromagnetic supports 18, 20, and 22 were approximately 10 N or less. The enhanced signal is added to electromagnetic control loop 41 just prior to CG-to-actuator matrix 46. Thus, the signals to electromagnetic supports 18, 20, and 22 are boosted when pneumatic supports 12, 14, and 16 are relatively far off the desired pressures and electromagnetic support control algorithm 44 near its response limit. This control scheme continues throughout processing.

Now referring to FIG. 6, we describe a schematic view illustrating photolithography apparatus 80 incorporating stage 36 that is driven by a planar motor and platform 10 that is coupled to base 9 in accordance with the principles of the present invention. The planar motor drives stage 36 by an electromagnetic force generated by magnets and corresponding armature coils arranged in two dimensions. Wafer 82 is held in place by wafer chuck 84 which is attached to stage 36. Platform 10 is structured so that it can move in multiple (e.g. three to six) degrees of freedom. Drive control unit 86, system controller 88 (which could include a CPU), and position stage 36 precisely control the position and orientation of platform 10 relative to the projection optics 110.

Voice coil motors and pneumatic supports (not shown), preferably three of each, levitate platform 10 in the vertical plane. At least three electromagnetic actuators (not shown) couple and move the platform 10 horizontally. The motor and pneumatic support array of platform 10 is supported by base 9. The reaction force generated by platform 10 motion can be mechanically released to the ground through a frame 90, in accordance with the structure described in) JP Hei 8-166475 and U.S. Pat. No. 5,528,118, the entire contents of which are incorporated by reference herein.

Frame 94 supports illumination system 92. Illumination system 92 projects a radiant energy (e.g. light) through a mask pattern on reticle 96 that is supported by and scanned using reticle stage 98. The reaction force generated by motion of the reticle stage can be mechanically released to the ground through isolator 100, in accordance with the structures described in JP Hei 8-330224 and U.S. Pat. No. 5,874,820, the entire contents of which are incorporated by reference herein. The light is focused through projection optics 110 supported on a projection optics frame 102 and released to the ground through frame 100.

Interferometer 104, which is supported on projection optics frame 102, detects the position of stage 36 and outputs the information of the position of stage 36 to system controller 88. Second interferometer 106, which is supported on reticle stage frame 108, detects the position of reticle stage 98 and outputs the information of the position to the system controller 88.

There are a number of different types of photolithographic devices. For example, photolithography apparatus 80 can be used as a scanning type photolithography system which exposes the pattern from reticle 96 onto wafer 82 with reticle 96 and wafer 82 moving synchronously. In a scanning type lithographic device, reticle 96 is moved perpendicular to an optical axis of illumination system 92 by reticle stage 98 and wafer 82 is moved perpendicular to an optical axis of illumination system 92 by stage 36. Scanning of reticle 96 and wafer 82 occurs while reticle 96 and wafer 82 are moving synchronously.

Alternately, photolithography apparatus 80 can be a step-and-repeat type photolithography system that exposes reticle 96 while reticle 96 and wafer 82 are stationary. In the step and repeat process, wafer 82 is in a constant position relative to reticle 96 and illumination system 92 during the exposure of an individual field. Subsequently, between consecutive exposure steps, wafer 82 is consecutively moved by stage 36 perpendicular to the optical axis of illumination system 92 so that the next field of wafer 82 is brought into position relative to illumination system 92 and reticle 96 for exposure. Following this process, the images on reticle 96 are sequentially exposed onto the fields of wafer 82 so that the next field of semiconductor wafer 82 is brought into position relative to illumination system 92 and reticle 96.

The use of photolithography apparatus 80 provided herein is not, however, limited to a photolithography system for a semiconductor manufacturing. Photolithography apparatus 80, for example, can be used as an LCD photolithography system that exposes a liquid crystal display device pattern onto a rectangular glass plate or a photolithography system for manufacturing a thin film magnetic head. Further, the present invention can also be applied to a proximity photolithography system that exposes a mask pattern by closely locating a mask and a substrate without the use of a lens assembly. The present invention may also be used in other devices, including other semiconductor processing equipment, machine tools, metal cutting machines, and inspection machines.

Illumination system 92 can be g-line (436 nm), i-line (365 nm), KrF excimer laser (248 nm), ArF excimer laser (193 nm) and F₂ laser (157 nm). Alternatively, illumination system 92 can use charged particle beams such as x-ray and electron beam. For instance, in the case where an electron beam is used, thermionic emission type lanthanum hexaboride (LaB₆) or tantalum (Ta) can be used as an electron gun. Furthermore, in the case where an electron beam is used, the structure could be such that either a mask is used or a pattern can be directly formed on a substrate without the use of a mask.

With respect to illumination system 92, when far ultra-violet rays such as the excimer laser is used, glass materials such as quartz and fluorite that transmit far ultra-violet rays are preferably used. When the F₂ type laser or x-ray is used, illumination system 92 should preferably be either catadioptric or refractive (a reticle should also preferably be a reflective type), and when an electron beam is used, electron optics should preferably comprise electron lenses and deflectors. The optical path for the electron beams should be in a vacuum.

Also, with an exposure device that employs vacuum ultra-violet radiation (VUV) of wavelength 200 nm or lower, the catadioptric type optical system may be appropriate. Examples of the catadioptric type of optical system include the disclosure Japan Patent Application Disclosure No. 8-171054 published in the Official Gazette for Laid-Open Patent Applications and its counterpart U.S. Pat. No. 5,668,672, as well as Japan Patent Application Disclosure No. 10-20195 and its counterpart U.S. Pat. No. 5,835,275. In these cases, the reflecting optical device can be a catadioptric optical system incorporating a beam splitter and concave mirror. Japan Patent Application Disclosure No. 8-334695 published in the Official Gazette for Laid-Open Patent Applications, and its counterpart U.S. Pat. No. 5,689,377 as wall as Japan Patent Application Disclosure No. 10-3039, and its counterpart U.S. Pat. No. 5,892,117 also use a reflecting-refracting type of optical system incorporating a concave mirror, etc., but without a beam splitter, and can also be employed with this invention. The disclosures in the abovementioned U.S. patents, as well as the Japan patent applications published in the Official Gazette for Laid-Open Patent Applications are incorporated herein by reference.

Further, in photolithography systems, when linear motors (see U.S. Pat. Nos. 5,623,853 or 5,528,118) are used in a wafer stage or a reticle stage, the linear motors can be either an air levitation type that employ air bearings or a magnetic levitation type that use Lorentz force or reactance force. Also, the stage could move along a guide, or be guideless. The disclosures in U.S. Pat. Nos. 5,623,853 and 5,528,118 are incorporated herein by reference.

Alternatively, one of the stages could be driven by a planar motor that drives the stage by electromagnetic force. This force is generated by a magnet unit having two-dimensionally arranged magnets and an armature coil unit having two-dimensionally arranged coils in facing positions. With this type of driving system, either the magnet unit or the armature coil unit is connected to the stage and the other unit is mounted on the moving plane side of the stage.

Movement of the stages as described above generates reaction forces which can affect performance of the photolithography system. Reaction forces generated by the wafer (substrate) stage motion can be mechanically released to the floor (ground) by use of a frame member as described in U.S. Pat. No. 5,528,118 and published Japanese Patent Application Disclosure No. 8-166475. Additionally, reaction forces generated by the reticle (mask) stage motion can be mechanically released to the floor (ground) by use of a frame member as described in U.S. Pat. No. 5,874,820 and published Japanese Patent Application Disclosure No. 8-330224. The disclosures in U.S. Pat. No. 5,874,820 and Japanese Patent Application Disclosure No. 8-330224 are incorporated herein by reference.

As described above, a photolithography system according to the above described embodiments can be built by assembling various subsystems, including each element listed in the appended claims, in such a manner that prescribed mechanical accuracy, electrical accuracy end optical accuracy are maintained. In order to maintain the various accuracies, prior to and following assembly, every optical system is adjusted to achieve its optical accuracy. Similarly, every mechanical system and every electrical system are adjusted to achieve their respective mechanical and electrical accuracies. The process of assembling each subsystem into a photolithography system includes mechanical interfaces, electrical circuit wiring connections and air pressure plumbing connections between each subsystem.

Needless to say, there is also a process where each subsystem is assembled prior to assembling a photolithography system from the various subsystems. Once a photolithography system is assembled using the various subsystems, a total adjustment is performed to make sure that every accuracy is maintained in the complete photolithography system. Additionally, it is desirable to manufacture an exposure system in a clean room where temperature and humidity are controlled.

Now referring to FIG. 7, which is a flow chart of a method for fabricating semiconductors, we describe a general process using the systems described above. In step 120 the device's function and performance characteristics are designed. In step 122 a mask (reticle) having a pattern is designed according to the previous designing step, and in a parallel step 123, a wafer is made from a silicon material. The mask pattern designed in step 122 is exposed onto the wafer from step 123 in step 124 by a photolithography system described hereinabove consistent with the principles of the present invention. In step 126 the semiconductor device is assembled (including the dicing process, bonding process and packaging process). Finally, the device is inspected in step 128.

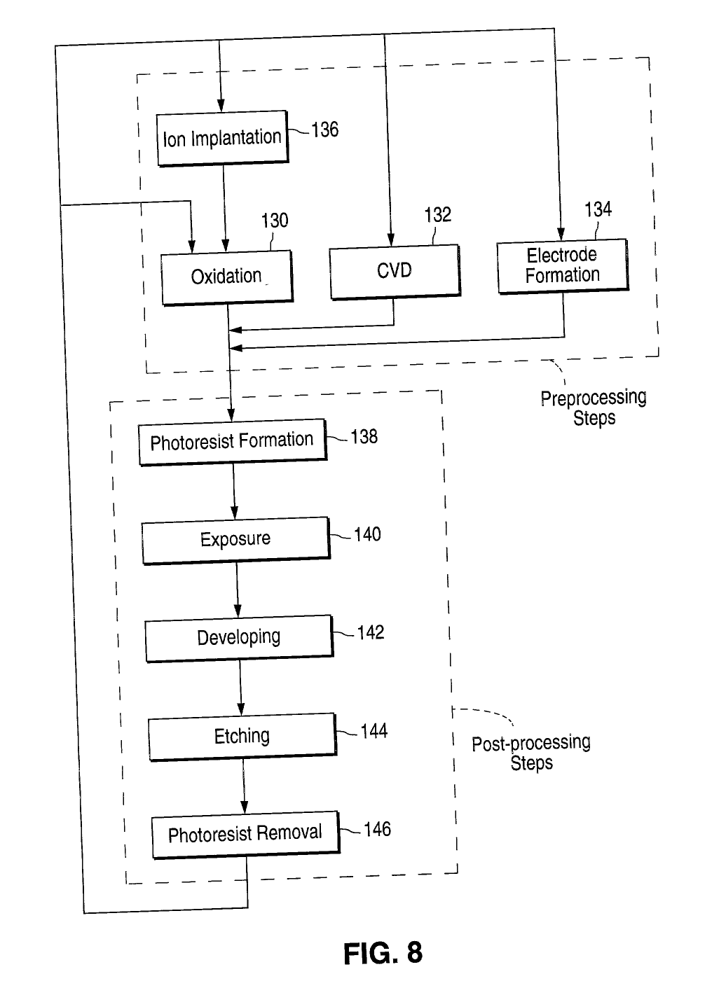

FIG. 8 is a detailed flowchart example of step 124 of the flowchart in FIG. 7. In step 130, the wafer surface is oxidized. In step 132, an insulation film is formed on the wafer surface via chemical vapor deposition (CVD). In step 134, electrodes are formed on the wafer by vapor deposition. In step 136 ions are implanted in the wafer. The above mentioned steps 130-136 form the preprocessing steps for wafers during wafer processing, and selections are made at each step according to processing requirements.

At each stage of wafer processing, when the above-mentioned preprocessing steps have been completed, the following post-processing steps are performed. Initially, in step 138, photoresist is applied to a wafer. In step 140 the above-mentioned exposure device is used to transfer the circuit pattern of a mask (reticle) to a wafer. Then, in step 142 the exposed wafer is developed, and in step 144 parts other than residual photoresist (exposed material surface) are removed by etching. In step 146 the unnecessary photoresist that remains after etching is removed. Multiple circuit patterns are formed by repetition of these preprocessing and post-processing steps.

While the foregoing description and drawings represent the preferred embodiments of the present invention, it will be understood that various additions, modifications and substitutions may be made therein without departing form the spirit and scope of the present invention as defined in the accompanying claims. In particular, it will be clear to those skilled in the art that the present invention may be embodied in other specific forms, structures, arrangements, proportions, and with other elements, materials, and components, without departing from the spirit or essential characteristics thereof. The presently disclosed embodiments are therefore to be considered in all respects as illustrative and not restrictive, the scope of the invention being indicated by the appended claims, and not limited to the foregoing description.

We claim:

1. An apparatus for supporting a stage, said apparatus comprising:
a base;
a platform supported from said base;
at least one stage configured to move about said platform;
a plurality of pneumatic supports configured on said base to support said platform in a first direction;
at least one air control valve that supplies and regulates each pressure of said plurality of pneumatic supports;
a plurality of active supports configured on said base to support said platform in said first direction; and
at least one amplifier that supplies and regulates the power to said active supports.

2. The apparatus of claim 1, said apparatus further comprising:
at least one pressure sensor that acquires data on the pressure in each said pneumatic support;
at least one position sensor that acquires data on the position of said platform with respect to said first direction; and
at least one location sensor that acquires data on the location of said at least one stage with respect to said platform.

3. The apparatus of claim 1, said apparatus further comprising three said pneumatic supports and three said active supports, each said pneumatic support being positionally paired with one said active support.

4. The apparatus of claim 2, said apparatus further comprising a control system comprising a processor and a computer program product containing a model that produces a target pressure for each said pneumatic support and instructions for:
receiving said data from said pressure, position, and location sensors;
producing target pressures for each said pneumatic support using said model and said stage location data;
comparing said target pressures to said acquired pressure data;
controlling said valve to change said acquired pressures so that said acquired pressures move toward said target pressures;
comparing said platform position data to a desired platform position; and
controlling said amplifiers to change said power to said active supports so that said acquired platform position moves toward said desired platform position.

5. The apparatus of claim 4, wherein said model comprises a matrix of a plurality of predetermined stage locations with a corresponding target pressure for each said pneumatic support at each said stage location and wherein said using said model comprises:
inputting said stage location data from said location sensors;
finding said predetermined location that is nearest to said input location; and
producing said target pressures corresponding to said nearest location.

6. The apparatus of claim 4, wherein said model comprises an equation with said equation producing said target pressures in response to an input stage location and said using said model comprises:
inputting said stage location data from said location sensors;
solving said equation; and
producing said target pressures from said solution.

7. The apparatus of claim 4 wherein said target pressures cause said pneumatic supports to support the majority of the weight of said platform and said stage.

8. An apparatus for supporting a stage, said apparatus comprising:
a base;
a platform supported from said base;
at least one stage configured to move about said platform;
a plurality of pneumatic supports configured on said base to support said platform in a first direction;
pressure control means for supplying and regulating each pressure of said plurality of pneumatic supports;
a plurality of active supports configured on said base to support said platform in said first direction; and
power control means for supplying and regulating the power to said active supports.

9. The apparatus of claim 1 wherein the number of pneumatic supports is the same as the number of active supports.

10. The apparatus of claim 2, said sensors comprising at least one interferometer.

11. The apparatus of claim 2, said sensor comprising at least on encoder.

12. The apparatus of claim 1, said apparatus further comprising control elements for controlling the location of said at least one stage on said platform.

13. A control system for controlling an apparatus for supporting a stage, said apparatus comprising a base from which a plurality of pneumatic supports and active supports support a platform which in turn supports said stage and sensors for sensing pneumatic support pressure, platform position, and stage location, said control system comprising:
a processor; and
a computer program product containing:
a model that produces a target pressure for each said pneumatic support; and
instructions for:
receiving data from pneumatic support pressure, platform position, and stage location sensors;
producing target pressures for each pneumatic supports using said model and said stage location data;
comparing said target pressures to said received pressure data;
controlling valves to change said pressures so that said received pressures move toward said target pressures;
comparing said received platform position data to a desired platform position; and
controlling amplifiers to change power to said active supports so that said acquired platform position data moves toward said desired platform position.

14. The apparatus of claim 13 wherein said target pressures cause said pneumatic supports to support the majority of the weight of said platform and said stage.

15. A method for supporting and vibrationally isolating a platform, the platform itself supporting at least one stage, the method comprising:
supporting a platform from a base using a plurality of pneumatic supports and a plurality of active supports, said platform itself supporting at least one stage and said platform having a desired position;
modeling said pneumatic supports, said model providing target pressures for each said pneumatic support for an input stage location;
moving said at least one stage about said platform during a process;
adjusting said pneumatic supports to said target pressures;
determining said platform position;
regulating said active supports to move said platform toward said desired platform position.

16. The method of claim 15 wherein said target pressures cause said pneumatic supports to support the majority of the weight of said platform and said stage.

17. The method of claim 15, said supporting step using three pneumatic supports and three active supports.

18. The method of claim 15, wherein said process is a lithography process.

19. The method of claim 15, wherein said desired platform position is substantially level.

20. The method of claim 15, said modeling comprising locating said at least one stage at a plurality of locations on said platform and determining a target pressure for each said pneumatic support for each said location; and said determining a target pressure for each said pneumatic support comprising:
comparing the position of said platform to said desired platform position;
adjusting said pressure at each said pneumatic support until said platform position attains said desired platform position;
designating said adjusted pressures as said target pressures for each said pneumatic support for said stage location.

21. The method of claim 20, said modeling further comprising:
determining target pressures at a plurality of stage locations along a first line of potential stage travel;
determining target pressures at a plurality of stage locations along a second line of potential stage travel;
combining said target pressures at locations along said first line with said target pressures at locations along said second line to create said model for the entirety of said platform surface traveled by said stage, said first and second directions being approximately orthogonal to one another.

22. The method of claim 20, said modeling further comprising creating a matrix of said target pressures corresponding to each said stage location.

23. The method of claim 20, said modeling further comprising creating an equation from said target pressures and corresponding stage locations, said equation having a gain.

24. The method of claim 20, said modeling further comprising creating both an equation and an associated matrix from said target pressures and corresponding stage locations, said equation having a gain.

25. The method of claim 24, said modeling further comprising a rough tuning step and a fine tuning step, said rough tuning step comprising:
moving said stage to a plurality of locations on said platform;
adjusting said pressure of each said pneumatic support until said platform is near said desired platform position for each said stage location;
recording said resulting pressures for said stage location; and
said fine tuning comprises:
moving said stage to a plurality of locations on said platform
regulating said active supports to force said platform to said desired platform position at each said stage location;
monitoring a voltage of each said active support, said voltage indicating the amount of force being exerted by said active support;
adjusting said pressures to force said voltages towards a desired voltage; and
recording said adjusted pressure as said target pressure for each said pneumatic support at said stage location.

26. The method of claim 24, said modeling further comprising creating a rough equation from said target pressures and corresponding stage locations after said rough tuning, said rough equation having a gain, and an alternate fine tuning step comprising:
regulating said active supports to force said platform to said desired platform position based on said rough equation;
monitoring a voltage of each said active support, said voltage indicating the amount of force being exerted by said active support;
adjusting said gain to force said voltages towards a desired voltage; and
designating said rough equation with said adjusted gain as said model.

27. The method of claim 24, said modeling further comprising creating both a rough matrix and a rough equation from said target pressures and corresponding stage locations after said rough tuning, said rough equation having a gain, and an alternate fine tuning step, said alternate fine tuning step comprising:
regulating said active supports to force said platform to said desired platform position based on said rough equation;
monitoring a voltage of each said active support, said voltage indicating the amount of force being exerted by said active support;
adjusting either or both of said gain and said target pressure value of said matrix to force said voltages towards a desired voltage; and
designating the combination of said rough equation with said adjusted gain and said matrix with said adjusted target pressures as said model.

28. The method of claim 24, said rough tuning comprising:
moving said at least one stage to a location on said platform;
adjusting said pressure at each said pneumatic support until said platform is near said desired platform position; and
recording said resulting pressures for each said stage location; and
said fine tuning comprising:
moving said at least one stage to a location on said platform, said location being one of the plurality of stage locations from said rough tuning;
controlling said pressures of said pneumatic supports towards said resulting pressures for said stage location;
regulating said active supports to force said platform to said desired platform position;
monitoring a voltage of each said active support;
adjusting said gain to force said voltages to a desired voltage; and
incorporating said adjusted gain into said model.

29. The method of claim 28, said rough tuning further comprising:
equipping said base with at least one hardstop to limit the travel of said platform; and said adjusting step comprising manual adjustments of said pressure until said base is not contacting said at least one hardstop.

30. A method for positioning and vibrationally isolating a platform and at least one stage in a process, said method comprising:
designating a desired platform position;
supporting said platform and stage primarily with a plurality of pneumatic supports from a base;
further supporting said platform and stage with a plurality of active supports;
moving said stage about said platform in a process;
determining the location of said stage as said stage is moved about said platform;
inputting said determined stage location into a model, said model providing a target pressure for each said pneumatic support based on said stage location;
adjusting said pneumatic support pressures to said target pressures;
comparing platform position after said adjusting step to said desired platform position; and
controlling said active supports to move said platform closer to said desired platform position.

31. The apparatus of claim 30 wherein said target pressures cause said pneumatic supports to support the majority of the weight of said platform and said stage.

32. The method of claim 30, said process comprising a lithography process.

33. The method of claim 30, wherein said model creation comprises:
moving said at least one stage about the surface of said platform to a plurality of fixed locations;
adjusting said pneumatic support pressures so that said platform is at said desired position when said at least one stage is at each said fixed location;
recording the pressure after each said adjustment;
creating a matrix of said recorded pneumatic support pressures and said fixed locations;
fine tuning said matrix, said fine tuning comprising:
monitoring said pressure of said pneumatic supports;
monitoring a voltage of said active supports;
monitoring said at least one stage location;
moving said at least one stage about the surface of said platform to said plurality of fixed locations and adjusting said pressures to new values to drive said voltages towards a desired voltage; and
revising said matrix with said new values.

34. An exposure apparatus including the apparatus of claim 1.

35. A device manufactured with the exposure apparatus of claim 34.

36. A wafer on which an image has been formed by the exposure apparatus of claim 34.

37. A method of making a wafer utilizing the method of claim 18.

38. A method of making a device utilizing the method of claim 18.

39. A method of making a wafer utilizing the method of claim 32.

40. A method of making a device utilizing the method of claim 32.

41. A stage device comprising:
a platform;
at least one stage supported by the platform, said at least one stage being movable relative to said platform;
at least one pneumatic support that supports said platform in a predetermined direction;
at least one active support connected to said platform, said at least one active support generating force that acts on the platform in said predetermined direction; and
a control system connected to said at least one pneumatic support and said at least one active support, said control system including a first control loop and a second control loop, wherein said first control loop controls said active support based on information related to position of said platform and said second control loop controls said at least one pneumatic support based on a position of said at least one stage independently from said information of said position of said platform.

42. The stage device of claim 41, further comprising a sensor that acquires data related to the pressure of said at least one pneumatic support, and wherein said first control loop controls said active support based on a relationship between a target pressure of said at least one pneumatic support and said data detected by said sensor.

43. An exposure apparatus including the stage device of claim 41.

44. A device manufactured with the exposure apparatus of claim 43.

45. A wafer on which an image has been formed by the exposure apparatus of claim 43.
